(19) United States
(12) Patent Application Publication
(10) Pub. No.: US 2009/0186640 A1
(43) Pub. Date: Jul. 23, 2009

(54) Presentation Of Promotional Messages On A Telecommunications Device

(76) Inventors: Harsha Niraj Gandhi, Pleasanton, CA (US); Vansh Niraj Gandhi, Pleasanton, CA (US); Vishant Niraj Gandhi, Pleasanton, CA (US); Niraj Rajkumar Gandhi, Pleasanton, CA (US)

Correspondence Address: MESCHKOW & GRESHAM, P.L.C., 5727 NORTH SEVENTH STREET, SUITE 409, PHOENIX, AZ, 85014, US

(21) Appl. No.: 12/331,725

(22) Filed: Dec. 10, 2008

Related U.S. Application Data
(60) Provisional application No. 61/022,325, filed on Jan. 19, 2008.

(51) Int. Cl. H04W 4/12; G06Q 30/00

(52) U.S. Cl. 455/466; 705/14

(57) ABSTRACT

A network (20) with at least one telecommunications device (22) and a promotional message server (24) transmits promotional messages (38) from the promotional message server (24) to the telecommunications device (22). Telecommunications device (22) presents the promotional message (38) on a display (74). A user can interact with the promotional message (38), permitting the user to connect with a company (25) that created the promotional message (38). The telecommunications device (22) transmits statistics to promotional message server (24) prior to receiving promotional messages (38) from the server (24). The promotional message server (24) determines how many promotional messages (38) to transmit to the telecommunications device (22).

### RELATED INVENTION

The present invention claims benefit under 35 U.S.C. §119(e) to “Promotional Or Other Messages Displayed On Incoming-Call-Screen Along With Caller ID Information On Telecommunications Device As Well As Associating That Message To The Said Call In The Device Call History,” U.S. Provisional Patent Application Ser. No. 61/022,325, filed Jan. 19, 2008, which is incorporated in its entirety by reference herein.

### TECHNICAL FIELD OF THE INVENTION

The present invention relates to the field of mobile telecommunications. More specifically, the present invention relates to displaying promotional messages on telecommunications devices.

### BACKGROUND OF THE INVENTION

Millions of calls are made and received daily to mobile and landline phones around the country and world. As each call is received by a telecommunications device, the network provider often transmits information to the telecommunications device providing the user with caller information. Often, a telecommunications device is provided with the phone number from which the incoming call has been made. In such situations, the telecommunications device may be able to determine whether the number belongs to any contact existing in the telecommunications device's memory.

The information provided by the telephone carrier, and any associated information from the telecommunications device itself, are presented on the telecommunications device's display. This information is in addition to traditional alerts such as ringing, vibrating, or both to attract the user's attention.

Although phones have been growing smaller, the area available for displaying information on the device has been increasing. However, this increasing display area is often not used effectively during any voice communication. Traditionally, the telecommunications device will display a phone number, if available, and possibly a name and/or picture, if these items are locally available on the telecommunications device, or transmitted from the network. This leaves large areas of the display unused when displaying information regarding incoming calls.

Furthermore, once a user accepts an incoming call, the initial information screen is often replaced with a screen that displays the call duration. Although many users still place their telecommunications device to their ear in order to have a voice communication, more and more users are choosing to utilize wired and/or wireless handsfree sets. Also, due to the fact that most individuals are charged for any period of time they spend on their telecommunications device, many people regularly view the telecommunications device display to note the call duration. Similar to the when incoming call information is displayed, large areas of the display often remains unused.

Once a user terminates a call on their telecommunications device, the device may display a call summary screen which displays the call duration. Again, the information to be displayed on this screen takes up minimal screen space, leaving unused space on the telecommunications device's display.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a simplified network in accordance with a preferred embodiment of the present invention;

FIG. 2 shows a block diagram of a promotional message server in accordance with a preferred embodiment of the present invention;

FIG. 3 shows a block diagram of a telecommunications device in accordance with a preferred embodiment of the present invention;

FIG. 4 shows a promotional message client update process in accordance with a preferred embodiment of the present invention;

FIG. 5 shows an incoming voice communication notification display in accordance with an alternative preferred embodiment of the present invention;

FIG. 6 shows a flow of how a promotional message is displayed in accordance with a preferred embodiment of the present invention;

FIG. 7 shows an on-going call duration display in accordance with an alternative preferred embodiment of the present invention; and

FIG. 8 shows call summary screen display in accordance with an alternative preferred embodiment of the present invention.

### DETAILED DESCRIPTION OF THE PREFERRED EMBODIMENTS

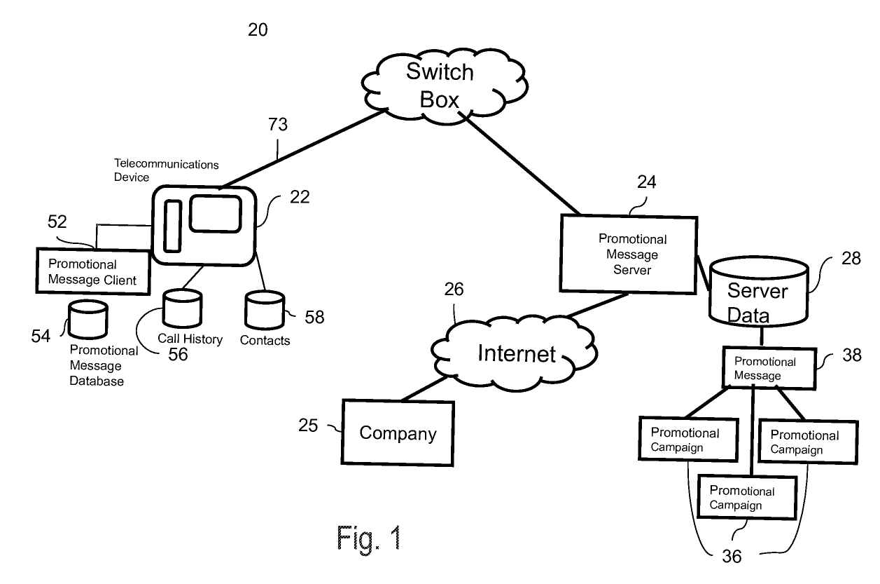

FIG. 1 shows a simplified network 20. In network 20, there is at least one telecommunications device 22 and at least one promotional message server 24. There may be more than one telecommunications device 22 communicating with one promotional message server 24. There may also be more than one promotional message server 24 in network 20. In one embodiment, there is more than one promotional message server 24 in network 20. Each of the more than one promotional message server 24 may be interconnected, to store data in multiple locations. In another embodiment, more than one promotional message server 24 is connected to network 20, however the promotional message servers 24 are not interconnected.

Promotional message server 24 is connected to both network 20 containing telecommunications device 22 and to the internet 26. Internet 26 connection is provided to promotional message server 24 in order to permit users to modify specific server data 28. Furthermore, a company 25 is connected to promotional message server 24 through internet 26.

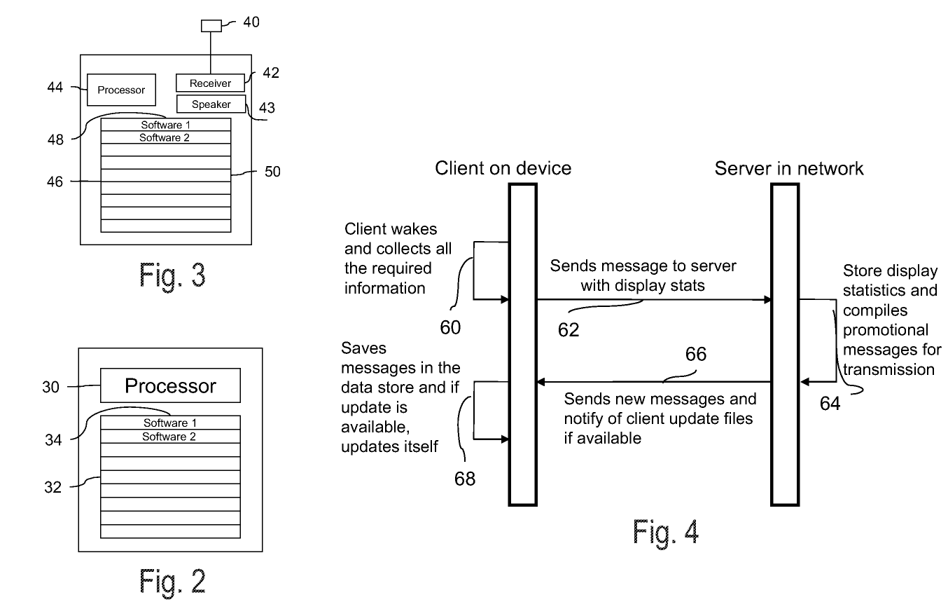

FIG. 2 is a block diagram of promotional message server 24. Promotional message server 24 has a processor 30 which controls the operation of promotional message server 24. A machine-readable medium 32 is connected to processor 30. Machine-readable medium 32 may be removable, read-only or read-write, may store machine-executable software 34 for promotional message server 24. Processor 30 may perform in accordance with software, applications or other instructions stored in machine-readable medium 32.

Returning to FIG. 1, promotional message campaign 36 is created by company 25 and stored as server data 28 on promotional message server 24. Promotional message campaign 36 is made up of one or more promotional messages 38, and may have restrictions as to what users are exposed to the promotional message, and at what times. Restrictions can be made for individual promotional messages 38 in promotional message campaign 36, or for all promotional messages 38 in promotional message campaign 36. In one embodiment, promotional messages 38 have only text characters. In an alternate embodiment, promotional messages 38 are made of graphical or picture representations. In still another embodiment, promotional messages 38 are a combination of both text and graphical representations. Furthermore, promotional messages 38 may contain a hyperlink that permits the user to connect to a particular website or call a particular number.

Promotional message server 24 also determines whether telecommunications device 22 (FIG. 1) is among the target group for promotional message 38 based upon the restrictions set as part of promotional campaign 36. If telecommunications device 22 is within the target group, promotional message server 24 configures promotional message 38 so that telecommunications device 22 can display promotional message 38. Promotional message server 24 also determines the number of promotional messages 38 that telecommunications device 22 should store and display. Promotional message server 24 connects to telecommunications device 22 through network 20. This connection permits promotional message server 24 to transmit promotional messages 38 (FIG. 3) to telecommunications device 22.

FIG. 3 is a block diagram of a telecommunications device 22. Telecommunications device 22 has an antenna 40 connected to a receiver 42, permitting telecommunications device 22 to receive voice and data communications from network 20. Voice communications are sent to audio speaker 43 for conversion to audio prior to the user hearing the communication. Voice and data communications between telecommunications device 22 and network 20 can be through any conventional protocol. If the protocol is wireless, conventional protocols, such as Code Division Multiple Access (CDMA), Global System for Mobile communications (GSM) or any other wireless voice and data communication protocol may be used. Receiver 42 is connected to a processor 44 which controls the operation of telecommunications device 22, including processing information received by receiver 42. A machine-readable medium 46 is connected to processor 44. Machine-readable medium 46 may be removable, read-only or read-write, may store machine-executable software 48 for telecommunications device 22.

Returning to FIG. 1, telecommunications device 22 has, stored in memory, a promotional message client 52, a promotional message database 54, and a call history 56. In one embodiment, telecommunications device 22 also has a contact list 58. Promotional message client 52 is a machine executable program configured to access information from either promotional message database 54, call history 56 or contact list 58 or any combination of the three.

FIG. 4 shows the promotional message client 52 update process. Promotional message client 52 causes processor 44 of telecommunications device 22 to transmit and receive data from network 20 to ensure that promotional message database 54 has at least one promotional message 38 to display. Telecommunications device 22 has a predetermined time at which it will update promotional message client 52. In a task 60, client 52 wakes at the predetermined time, and collects information regarding the performance of client 52 since the last update. In one embodiment, the predetermined time is a set time at which the update of promotional message client 52 will take place. In another embodiment, the predetermined time is determined when telecommunications device 22 is idle or sleeping. In still another embodiment, server 24 allocates a time slot in which client 52 can contact server 24 to receive promotional message 38. In still another embodiment, the predetermined time is set by client 52 when client 52 determines if an update is available. The information collected includes statistics of how many times and when promotional messages 38 currently stored in promotional message database 54 were displayed. Client 52 keeps track of this information in real time, collecting this tracked information in task 62. Then, in a task 62, telecommunications device 22 transmits this information to promotional message server 24 over network 20.

Upon receiving the information from promotional message client 52, promotional message server 24 performs task 64 in which server 24 stores all the information transmitted in task 62, and compiles promotional message 38 to be transmitted to telecommunications device 22. Then, a task 66 is performed, in which server 24 will determine the number of messages to transmit to promotional message client 53, and transmit new promotional messages 38 to promotional message client 52. Along with new promotional messages 38, promotional message server 24 will transmit notification to client that update files to promotional message client 52 are available. Once the new promotional messages 38 are received, promotional message client 52 performs task 68, saving the received promotional messages 38 in promotional message database 54, and updating itself. In one embodiment, the communication between promotional message client 52 and promotional message server 24 is asynchronous, thus not requiring any confirmation of receipt from either device.

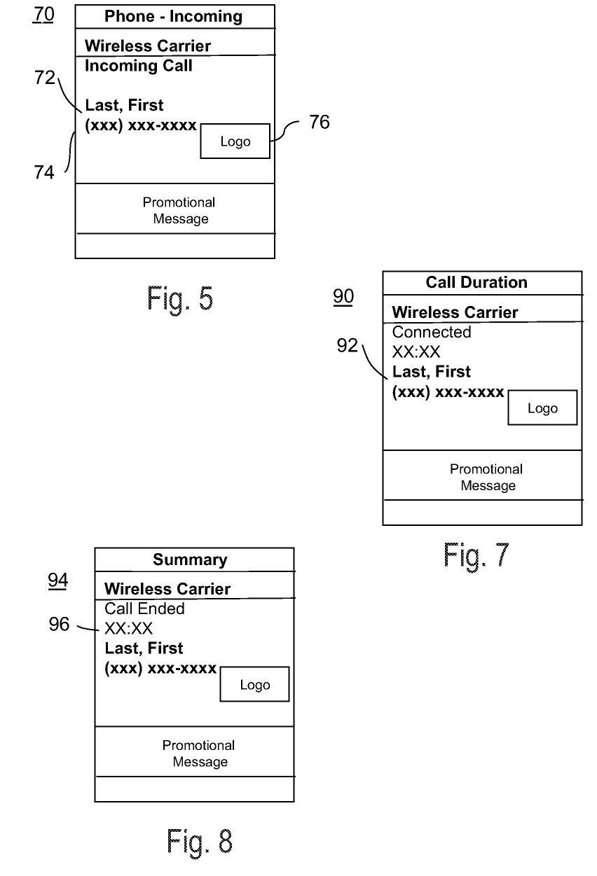

FIG. 5 shows a display layout for telecommunications device 22 displaying an incoming voice communication notification 70. Incoming voice communication notification 70 consists of caller information 72 and promotional message 38. When an information 72 is provided to telecommunications device 22 regarding an incoming voice communication 73, that information is displayed on display 74. Information 72 may consist of just a phone number, a phone number and a name, or information that the phone number is blocked. Telecommunications device 22 may display this information on display 74, as incoming voice communication notification 70.

If information 72 has been stored in contact list 58 of telecommunications device 22, telecommunications device 22 may display the stored contact information in incoming voice communication notification 70. Contact list information 72 may be a name, a picture, or a combination of both a name and picture.

In one embodiment promotional message client 52 may also store in contact list 58 a company logo 76. Company logo 76 will be displayed on incoming voice communication notification 70, as part of information 72.

Promotional message 38 is displayed in incoming voice communication notification 70 such that a user can view both promotional message 38 and caller information 72 at the same time. In one embodiment, telecommunications device 22 determines whether incoming voice communication 73 is from a phone number found in contact list 58. If information 72 is found in contact list 58, telecommunications device 22 will determine whether contact list 58 contains a company name. If there is a company name, and if company logo 76 is available then company logo 76 will be shown on the incoming voice communication notification 70 along with information 72 and promotional message 38. In another embodiment, promotional message client 52 selects a promotional message 38 from promotional message database 54 without examining contact list 58 for company name.

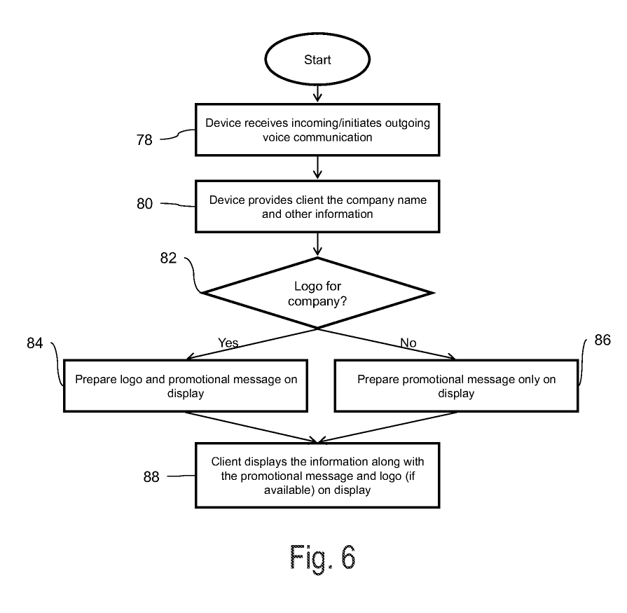

FIG. 6 shows a flow of how promotional message 38 is displayed on telecommunications device 22. In a task 78, telecommunications device 22 either receives or initiates voice communication 73. Once task 78 is completed, a task 80 wakes client 52, and client 52 provides telecommunications device 22 with the name of company 25 and any other information 72 that telecommunications devices 22 has about the person that is either calling or receiving a call from telecommunications device 22.

After telecommunications device 22 receives the name of company 25 and other information 72 from client 52, a query task 82 determines if telecommunications device 22 has a company logo 76 for company 25 stored. Company logo 76 may be on telecommunications device 22 or on promotional message server 24. If company logo 76 does exist, a task 84 is performed, where both promotional message 38 and company logo 76 are prepared for to be presented on display 74. If company logo 76 does not exist, a task 86 is performed where only promotional message 38 is prepared for display 74. Once task 84 or task 86 is completed, a task 88 is performed, where client 52 presents what was prepared in task 84 or task 86. Also, promotional message 38 is associated with voice communication 73 in call history 56 and displayed on display 74 when call history 56 is displayed.

FIG. 7 shows a display layout for telecommunications device 22 displaying an on-going call duration 90. On-going call duration 90 has promotional message 38 and call timer 92. Call timer 92 notifies the user the duration of a voice communication 73. If call timer 92 is timing an incoming voice communication 73, promotional message 38 is the same promotional message 38 shown in incoming voice communication notification 70. If call timer 92 is timing an outgoing voice communication 73, promotional message client 52 will select a promotional message 38 from promotional message database 54 similar to how one was selected for incoming voice communication notification 70.

FIG. 8 shows a display layout for telecommunications device 22 displaying a summary screen 94. Summary screen 94 has promotional message 38 and call duration 96. Call duration 96 is the total time of the voice communication 73. Promotional message 38 displayed on summary screen 94 is the same promotional message as displayed in on-going call duration 90.

In summary, the present invention teaches displaying promotional message 38 on a telecommunications device 22. Promotional message 38 is shown on display 74 in space that remains after information 72 is displayed.

Promotional message 38 is shown on display 74 when incoming voice communication notification 70 is provided to a user. If the user accepts the incoming voice communication 73, the same or different promotional message 38 is then displayed along with call timer 92 in on-going call duration 90. At the termination of the voice communication 73, the same or a different promotional message is displayed along with call duration 96 in call summary screen 94.

If the user initiates an outgoing voice communication 73, promotional message 38 is displayed along with call timer 92 in on-going call duration 90. At the termination of the voice communication 73, the same promotional message is displayed in space remaining on display 74 after call duration 96 is displayed in call summary screen 94.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A method for presenting promotional messages on a telecommunications device, said method comprising:
receiving a promotional message at said telecommunications device from a promotional message server;
storing, after said receiving activity, said promotional message on said telecommunications device;
presenting said promotional message on a display of said telecommunications device, in association with a voice communication.

2. A method as claimed in claim 1, wherein said promotional message is received from said promotional message server by said telecommunications device over a network.

3. A method as claimed in claim 1, wherein:
said transmitting activity further comprises transmitting a first data communication to said telecommunications device, said first data communication comprising data configured for visual presentation on said display; and
said incoming voice communication is a second data communication comprising data configured for audio presentation through an audio speaker on said telecommunications device.

4. A method as claimed in claim 1, wherein:
said voice communication is an incoming voice communication; and
said presenting activity further comprises presenting said promotional message when information from which said incoming voice communication originates is presented on said display.

5. A method as claimed in claim 1, wherein said presenting activity further comprises presenting said promotional message on said display for the duration of said voice communication.

6. A method as claimed in claim 1, wherein said presenting activity further comprises presenting said promotional message on said display at a termination of said voice communication on a summary screen, said summary screen comprising a display of call duration for said voice communication.

7. A method as claimed in claim 1, wherein said presenting activity further comprises presenting said promotional message on said display in a call history.

8. A method as claimed in claim 1 further comprising:
creating a promotional message campaign comprising said at least one promotional message;
determining whether said telecommunications device is a target for said promotional message campaign; and
transmitting said one of said at least one promotional message to said telecommunications device if said telecommunications device is a target for said promotional message campaign.

9. A method as claimed in claim 1 wherein said promotional message is an active hyperlink that when activated will connect telecommunications device to a company that created promotional message.

10. A method as claimed in claim 1 further comprising presenting a company logo on said display if an information for said voice communication is found in a contact list.

11. A machine-executable program residing upon a machine-readable medium and executable by a processor of a telecommunications device, said machine-executable program causing said processor to perform operations comprising:
receiving a promotional message at said telecommunications device from a promotional message server;
storing said promotional message on said telecommunications device;
initiating a voice communication at said telecommunications device; and
presenting said promotional message on a display of said telecommunications device, in association with said voice communication.

12. A machine-executable program as claimed in claim 11, wherein said machine-executable program is configured to receive said promotional message through a network.

13. A machine-executable program as claimed in claim 11, wherein said presenting activity further comprises presenting said promotional message when information from which said voice communication originates is presented on said display.

14. A machine-executable program as claimed in claim 11, wherein said presenting activity further comprises presenting said promotional message on said display for the duration of said voice communication.

15. A machine-executable program as claimed in claim 11, wherein said presenting activity further comprises presenting said promotional message on said display at termination of said voice communication on a summary screen, said summary screen comprising a display of call duration for said voice communication.

16. A machine-executable program as claimed in claim 15 wherein said connecting said telecommunications device is through a voice communication.

17. A machine-executable program as claimed in claim 15, wherein said operations further comprise:
determining whether all stored promotional messages have been displayed on said telecommunications device;
transmitting through said network to said promotional message server a request if all stored promotional messages have been displayed, wherein said request comprises a display statistic and a request for a promotional message; and
receiving at least one promotional message in response to said request.

18. A machine-executable program as claimed in claim 11 wherein said operations further comprise:
activating said promotional message on said display;
connecting said telecommunications device to a company that created said promotional message.

19. A machine-executable program residing upon a machine-readable medium and executable by a processor of a promotional message server connected to a network comprising a telecommunications device, said machine-executable program causing said processor to perform operations comprising:
creating a promotional message campaign, comprising a promotional message;
determining whether said telecommunications device is a target for said promotional message campaign; and
configuring said promotional message for presentation on a display of said telecommunications device;
transmitting said promotional message to said telecommunications device if said telecommunications device is a target for said promotional message campaign.

20. A machine-executable program as claimed in claim 19, wherein said operations further comprises:
receiving a request from said telecommunications device;
determining the number of promotional messages to transmit to said telecommunications device; and
transmitting said number of promotional messages to said telecommunications device.

21. A machine-executable program residing upon a machine-readable medium and executable by a processor of a telecommunications device, said machine-executable program causing said processor to perform operations comprising:
initiating an voice communication at said telecommunications device; and
presenting a company logo on a display of said telecommunications device.

22. A machine-executable program as claimed in claim 21, wherein:
said telecommunications device is connected to a promotional message server through a network; and
said company logo is transmitted to said telecommunications device when said initiation is performed, if said voice communication has an information that is found in a contact list on said telecommunications device.
